(19) United States
(12) Patent Application Publication
(10) Pub. No.: US 2014/0111560 A1
(43) Pub. Date: Apr. 24, 2014

(54) LIQUID CRYSTAL DISPLAY DEVICE

(71) Applicant: Ryo Yamakawa, Osaka (JP)

(72) Inventor: Ryo Yamakawa, Osaka (JP)

(73) Assignee: SHARP KABUSHIKI KAISHA, Osaka (JP)

(21) Appl. No.: 14/122,637

(22) PCT Filed: May 30, 2012
(86) PCT No.: PCT/JP2012/063896

§ 371 Date: Nov. 26, 2013

(30) Foreign Application Priority Data
Jun. 1, 2011 (JP) 2011-123756

(51) Int. Cl. G09G 3/34

(52) U.S. Cl. CPC G09G 3/3406
USPC 345/690; 345/102

(57) ABSTRACT

A liquid crystal display device (A) that can suppress variation in gradation of color temperature even if there is variation in components during production, the liquid crystal display device being provided with: an image signal generating section (4) that generates an LED data signal on the basis of display image information; a backlight driving section (5); an LED adjusting table (501) having a plurality of correction coefficients; and an LED data signal correcting section (51) that corrects the LED data signal with the correction coefficient by referring to the LED adjusting table (501).

### TECHNICAL FIELD

The present invention relates to a liquid crystal display device used in a flat-screen television receiver or the like.

### BACKGROUND ART

A liquid crystal display device includes a backlight unit, and a liquid crystal panel unit arranged on the front surface of the backlight unit. In the liquid crystal display device, the brightness of planar light emitted from the backlight unit is adjusted on the basis of input images (image data) in order to increase the contrast of display images that are displayed by the liquid crystal panel unit and to reduce the power consumption of the backlight unit.

Area active backlight units have recently emerged in which the display screen is divided into a plurality of areas, with the backlight unit also being divided into portions corresponding to these areas. Planar light having a brightness that exercises the input image for each area is incident on the respective areas.

With a liquid crystal display device having this area active backlight, a further increase of display image contrast can be achieved along with a further reduction in power consumption due to the brightness of light emitted from the backlight unit being adjusted for each area in accordance with the input image. It is common for LEDs to be used as the light sources in such area active backlight units (see Japanese Patent Application Laid-Open Publication No. 2010-134269 and the like).

### RELATED ART DOCUMENT

### Patent Document

Patent Document 1: Japanese Patent Application Laid-Open Publication No. 2010-134269

### SUMMARY OF THE INVENTION

### Problems to be Solved by the Invention

It is preferable for the liquid crystal display device to have characteristics that allow a substantially uniform color temperature from low gradation to high gradation. The color temperature, however, may have variation caused by changes in gradation because of various reasons, such as the thickness of liquid crystal cells in the liquid crystal panel unit, film thickness of the color filters, and the like.

In other words, the thickness of liquid crystal cells, film thickness of the color filters, and the like varies during manufacturing of the liquid crystal display device, leading to a change (variation) between low gradation and high gradation for color temperature of the liquid crystal display device. This lowers the image display quality of the liquid crystal display device. This variation in color temperature caused by gradation (gradation characteristics) becomes markedly easier to see, the higher the color temperature is.

For conventional liquid crystal display devices, it is possible to suppress variation in color temperature caused by gradation by stringently managing the manufacturing process, and highly suppressing deviation in the thickness of the liquid crystal cells, film thickness of the color filters, and the like; however, this increases the time needed for manufacturing. There are also methods for post-manufacturing inspections that remove elements that have color temperature gradation characteristics deviating from a uniform range, but this lowers the yield of liquid crystal display devices.

Furthermore, operating the liquid crystal panel unit, the backlight unit, and the like for long periods of time causes deterioration (time deterioration) of the liquid crystal display device. This time deterioration may cause variation in the color temperature caused by differences in gradation.

The present invention aims at providing a liquid crystal display device that can suppress a reduction in image display quality by suppressing variation in color temperature due to differences in gradation, which is caused by variation in components during production and time deterioration.

### Means for Solving the Problems

In order to achieve the above-mentioned aim, the present invention includes: a liquid crystal panel; a backlight that is arranged on a rear surface of the liquid crystal panel and that has LEDs as light sources, each of the LEDs comprising elements that respectively emit light of a red color, a green color, or a blue color; a signal generating section that generates an LED data signal on the basis of information of a display image, the LED data signal adjusting respective light-emitting luminances of the LEDs; and a backlight driving section that controls the LEDs being turned ON and OFF on the basis of the LED data signal, wherein the backlight driving section includes: an LED adjusting table including a plurality of correction coefficients that correct chromaticity of the LEDs; and an LED data signal correcting section that corrects the LED data signal with the control coefficients by referring to the LED adjusting table.

With this configuration, the chromaticity of the LEDs can be corrected by correcting the LED data signal with the correction coefficients included in the LED adjusting table. This makes it possible to prevent variation in chromaticity and color temperature in the liquid crystal display device and to preserve image display quality with high precision.

In the above-mentioned configuration, the LED data signal correcting section may correct the LED data signal such that the LED data signal, after correction, individually configures luminances of the elements of the LEDs that respectively emit the red light, the green light, or the blue light. The LED data signal is corrected to adjust the luminance of the elements of the LEDs that respectively emit the red, green, or blue light, and thus, chromaticity and color temperature of the LEDs can be corrected with ease.

In the above-mentioned configuration, the LED adjusting table is a table in which a correction coefficient is configured for each gradation of the display image, and the LED data signal correcting section may receive gradation information of the display image from the signal generating section, and obtain a correction coefficient in accordance with the gradation information of the display image from the LED adjusting table.

With this configuration, it is possible to suppress variation in color temperature and chromaticity as the gradation of the image changes. This makes it possible to suppress a reduction of display image precision in the liquid crystal display device.

In the above-mentioned configuration, the LED adjusting table may be a table comprising correction coefficients such that a luminance of the blue color is high when the gradation is low and a luminance of the red color is high when the gradation is high.

In the above-mentioned configuration, the LED adjusting table may be a table that is optimized for the individual liquid crystal panel. The LED adjusting table may detect a color temperature for each gradation after the manufacturing of the liquid crystal panel is complete, and a difference between the color temperatures may be configured to be within a uniform range.

The above-mentioned configuration may include: a time deterioration detecting part that detects time deterioration of the liquid crystal panel; a time deterioration correcting table that is included in the backlight driving section and that corrects chromaticity of the LEDs; and a time deterioration correcting unit that is included in the backlight driving section and that corrects the LED data signal by referring to the time deterioration correcting table.

The above-mentioned configuration may: a time deterioration detecting part that detects time deterioration of the liquid crystal panel; a time deterioration correcting table that is included in the backlight driving section and that corrects chromaticity of the LEDs; and is included in the backlight driving section and that corrects the LED adjusting table by referring to the time deterioration correcting table.

The above-mentioned configuration may include: an LED time deterioration detecting part that detects time deterioration of the LEDs; an LED time deterioration correcting table that is included in the backlight driving section and that corrects chromaticity of the LEDs; and an LED time deterioration correcting unit that is included in the backlight driving section and that corrects the LED data signal by referring to the LED time deterioration correcting table.

The above-mentioned configuration may include: an LED time deterioration detecting part that detects time deterioration of the LEDs; an LED time deterioration correcting table that is included in the backlight driving section and that corrects chromaticity of the LEDs; and an LED time deterioration correcting unit that is included in the backlight driving section and that corrects the LED adjusting table by referring to the LED time deterioration correcting table.

### Effects of the Invention

According to the present invention, variation in color temperature due to differences in gradation, which are caused by the variation of components used during production and time deterioration, can be suppressed, and a reduction in image display quality can be controlled by adjusting the chromaticity of backlight LEDs in accordance with changes in gradation of an image to be displayed.

### BRIEF DESCRIPTION OF THE DRAWINGS

FIG. 1 is an exploded perspective view of one example of a liquid crystal display device according to the present invention.

FIG. 2 is a block diagram showing a schematic configuration of the liquid crystal display device in FIG. 1.

FIG. 3 is a graph showing a relationship between xy chromaticity and gradation of the liquid crystal display device when a white light with a color temperature of 14000 K is emitted from the backlight unit.

FIG. 4 is a graph showing a relationship between color temperature and gradation of the liquid crystal display device with the same conditions as FIG. 3.

FIG. 5 is a graph showing a relationship between xy chromaticity and gradation of the liquid crystal display device when a white light with a color temperature of 8500 K is emitted from the backlight unit.

FIG. 6 is a graph showing a relationship between color temperature and gradation of the liquid crystal display device with the same conditions as FIG. 5.

FIG. 7 is a flow chart showing the decision procedure for an LED adjusting LUT.

FIG. 8 is a block diagram showing a schematic configuration of another example of a liquid crystal display device according to the present invention.

FIG. 9 is a flow chart showing the procedure for correcting time deterioration.

FIG. 10 is a block diagram showing a schematic configuration of another example of a liquid crystal display device according to the present invention.

### DETAILED DESCRIPTION OF EMBODIMENTS

Embodiments of the present invention will be explained below with reference to the drawings.

### Embodiment 1

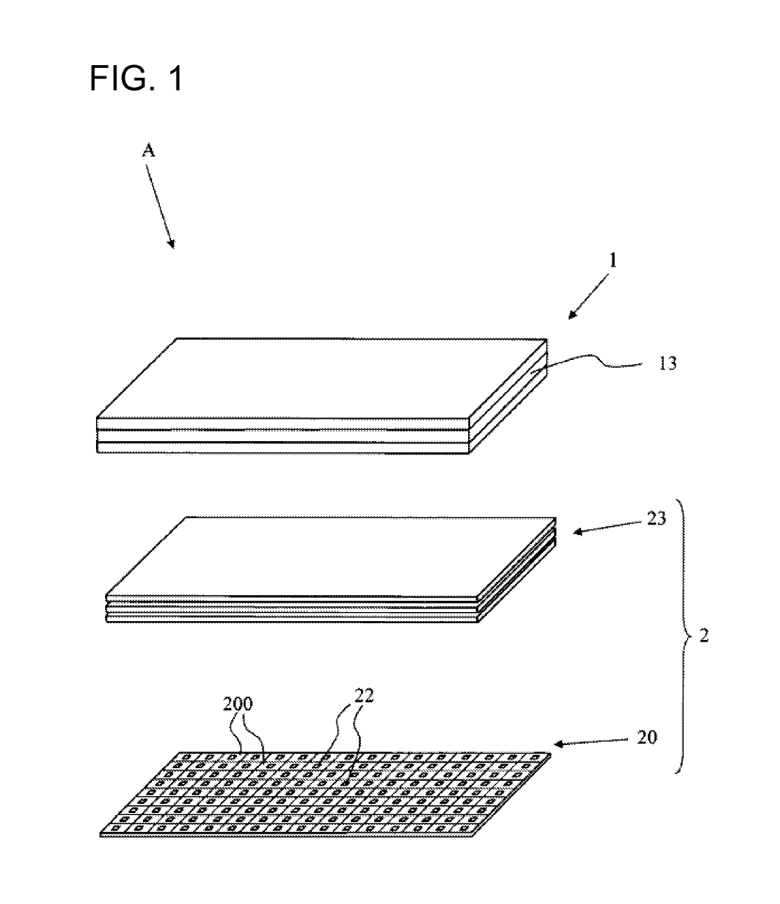

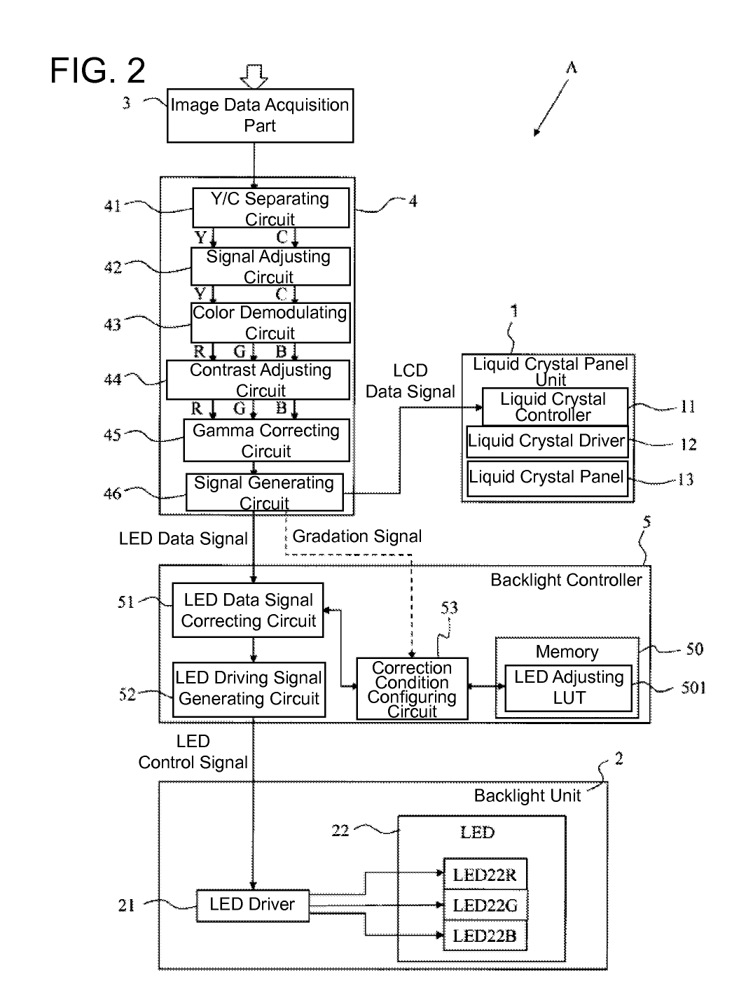

FIG. 1 is an exploded perspective view of one example of a liquid crystal display device according to the present invention, and FIG. 2 is a block diagram showing a schematic configuration of the liquid crystal display device shown in FIG. 1. A liquid crystal display device A includes a liquid crystal panel unit 1, a backlight unit 2 (a backlight), an image data acquisition part 3, an image signal processing unit 4 (a signal generating section), a backlight controller 5 (a backlight driving section), and the like. As shown in FIG. 2, the liquid crystal display device A is a laterally long rectangle that is integrally held by a frame-shaped bezel (not shown) or the like.

As shown in FIG. 2, the liquid crystal panel unit 1 has a liquid crystal controller 11, a liquid crystal driver 12, and a liquid crystal panel 13. The liquid crystal panel 13 is formed in a rectangular shape in a plan view, and a pair of glass substrates is bonded together through a prescribed gap, having liquid crystal sealed therebetween.

In the liquid crystal panel 13, switching devices (TFTs, or thin-film transistors, for example) connected by mutually intersecting source wiring lines and gate wiring lines are provided on one glass substrate, along with a pixel electrode connected to each of these switching devices, and an alignment film and the like also provided on the glass substrate. Color filters, which have respective colored parts of R (red), G (green), B (blue) and the like arranged in prescribed arrays, a common electrode, and an alignment film and the like are provided on the other glass substrate. Polarizing plates are respectively provided on outer sides of the two substrates.

With such a configuration, the liquid crystal panel unit 1 has 1920×1080 high-definition color pixels formed therein, for example.

The liquid crystal controller 11 generates signals for driving the liquid crystal driver 12 on the basis of LCD data signals sent from the image signal processing unit 4, and sends these generated signals to the liquid crystal driver 12. The liquid crystal driver 12 switches the state of the switching device of each pixel in the liquid crystal panel 13 on the basis of signals received from the liquid crystal controller 11.

This adjusts the voltage of each pixel electrode provided in the liquid crystal panel 13 in accordance with the image data, and applies this voltage to the pixel electrode arranged in the corresponding pixel. This changes the permeation degree of light (transmittance) in each pixel with respect to the liquid crystal due to the electric field between the pixel electrodes. In the liquid crystal display device A, the transmittance level of light for each pixel is adjusted and an image displayed on the screen by planar light from the backlight unit 2 is incident on the liquid crystal panel unit 1.

The backlight unit 2 is an illumination device that is driven by LED control signals generated by the LED controller 5, described later, to illuminate the liquid crystal panel unit 1 with planar light. The backlight unit 2 includes an LED mounting substrate (an LED panel) 20 (see FIG. 1), an LED driver 21, LEDs (light emitting diodes) 22, an optical member 23 with a diffusion plate, optical sheets, and the like. In the backlight unit 2, the LEDs 22 are mounted on a mounting surface of the LED panel 20 facing the liquid crystal panel unit 1.

The LED panel 20 has a plurality of areas 200 arrayed in a matrix. The areas 200 are configured to contain at least one LED 22. As shown in FIG. 1, in the backlight unit 2, the LED panel 20 has 16 areas 200 horizontally and 9 areas 200 vertically (a total of 144), for example. The LED driver 21 drives (light emitting driving) the LED 22 in each area 200 on the basis of LED control signals, described later, from the LED controller 5. The LED data signal, and the LED control signal generated on the basis of the LED data signal, are sent to each area 200.

Each LED 22 is constituted of an LED unit that combines an LED chip (a red LED chip) 22R that emits red wavelength light, an LED chip (a green LED chip) 22G that emits green wavelength light, and an LED chip (a blue LED chip) 22B that emits blue wavelength light. The LED unit emits light of every wavelength in order to emit a white light overall.

The brightness of the LEDs 22 is adjusted by adjusting the light emitting time. In other words, a longer lighting time of the LEDs 22 means a higher brightness, and a shorter lighting time means a lower brightness. This light emitting time of the LEDs 22 is controlled by PWM (pulse width modulation) control, and the LED controller 5 generates a lighting duty ratio for the PWM control on the basis of the LED data signals. 12-bit digital signals are used for the LED data signals, for example. The lighting duty ratio is the proportion that the signal is ON in one cycle, and thus, a larger lighting duty ratio means a longer length of time that the LEDs 22 are lit (higher brightness), and a smaller lighting duty ratio means a shorter time that the LEDs 22 are lit (lower brightness).

As shown above, in the backlight unit 2 the brightness of the LEDs 22 mounted on the LED panel 20 can be adjusted for every area. In other words, the backlight unit 2 is a so-called area active backlight unit that can irradiate the liquid crystal panel unit 1 with planar light (having a brightness distribution) that has had the brightness thereof adjusted for each area 200. In the area active backlight unit 2, power consumption can be reduced without lowering the contrast of the image by emitting light in accordance with the brightness of the image displayed by the liquid crystal panel unit 1, namely, emitting a high brightness where the image brightness is high, and emitting a low brightness where the image brightness is low.

In the backlight unit 2, the LED driver 21 can independently adjust the brightness of the red LED chip 22R, green LED chip 22G, and blue LED chip 22B of the LED 22 arranged in each area 200. If the brightness of the red LED chip 22R is increased, then the chromaticity of red in the white light emitted from the LED 22 will be increased, for example. The green LED chip 22G and blue LED chip 22B are also independent in a similar manner; in other words, the brightness can be changed by instruction from the LED driver 21. A detailed explanation will be given later.

The image data acquisition part 3 is an interface for inputting external image signals. In the image data acquisition part 3, television broadcast signals are received, converted to image signals, and then sent to the image signal processing unit 4.

The image signal processing unit 4 generates LCD data signals that drive the liquid crystal panel unit 1 and LED data signals that drive the backlight unit 2 on the basis of the inputted image signals. The image signal processing unit 4 includes: a Y/C separating circuit 41 that separates the image signals into luminance signals Y and color signals C; a signal adjusting circuit 42 that processes the luminance signals Y and color signals C independently; a color demodulating circuit 43 that demodulates the adjusted brightness signals Y and color signals C into RGB signals; a contrast adjusting circuit 44 that adjusts the contrast; a gamma correcting circuit 45 that corrects the gamma; and a signal generating circuit 46 that generates LED data signals and LCD data signals from the gamma-corrected RGB signals.

The LED data signals generated by the signal generating circuit 46 are sent to the backlight controller 5, and the LCD data signals are sent to the liquid crystal controller 11. The signal generating circuit 46 also sends gradation information included in the image signals to the backlight controller 5 as a gradation signal.

The backlight controller 5 includes: an LED data signal correcting circuit 51 (an LED data signal correcting section) that corrects the color temperature of the LED data signals; an LED driving signal generating circuit 52 that generates LED driving signals from the corrected LED data signals; a correction condition configuring circuit 53 that configures the conditions for correction by the LED data signal correcting circuit 51; and a memory 50 that stores an LED adjusting LUT 501 (an LED adjusting table), which is a look-up table (LUT) used for correction.

The memory 50 includes a readable/writable RAM, a read-only ROM, and the like, and can store necessary data for driving the backlight controller 5. The LED adjusting LUT 501 for correcting the LED data signals is stored in the memory 50 described above. The correction condition configuring circuit 53 can access the LED adjusting LUT 501 stored in the memory 50 at all times.

The LED adjusting LUT 501 is a look-up table with a configured backlight unit 2 LED chromaticity (the proportion of brightness of the red LED chip 22R, green LED chip 22G, and blue LED chip 22B) for the gradation of every inputted image signal. The LED adjusting LUT 501 is a look-up table configured for the liquid crystal display device A, as described in detail later.

The correction condition configuring circuit 53 receives image gradation information (gradation signals), which is included in the image data inputted to the liquid crystal display device A from the signal generating circuit 46. The correction condition configuring circuit 53 is a circuit that takes a correction coefficient from the LED adjusting LUT 501 on the basis of the gradation information and the color temperature (in other words, the light emitting brightness of the LEDs determined by the LED data signals), and then sends this correction coefficient to the LED data signal correcting circuit 51.

The LED data signal correcting circuit 51 configures (records) the correction coefficient for correcting the LED data signals so as to be updatable (rewritable). The LED data signal correcting circuit 51 uses the correction coefficient to generate an adjusted LED data signal in which the chromaticity of the LED data signal has been corrected. The adjusted LED data signals are sent to the LED control signal generating circuit 52.

The adjusted LED data signals are data that indicate the brightness of each LED 22 included in each of the plurality of areas 200. The adjusted LED data signals act as data that can independently control lighting for the red LED chip 22R, green LED chip 22G, and blue LED chip 22B. This adjusted LED data signal independently adjusts the brightness of the red LED chip 22R, green LED chip 22G, and blue LED ship 22B.

The LED driving signal generating circuit 52 generates, on the basis of LED data signals sent from the LED data signal correcting circuit 51, LED control signals containing the PWM signal that drives the lighting of the LEDs 22 (the red LED chip 22R, green LED chip 22G, and blue LED chip 22B) included in the areas 200. The LED driving signal generating circuit 52 then sends this signal to the LED driver 21. This PWM signal is independently configured for each red LED chip 22R, green LED chip 22G, and blue LED chip 22b.

The LED driver 21 drives the lighting for the red LED chip 22R, green LED chip 22G, and blue LED chip 22B on the basis of the LED control signals. In the backlight unit 2, the brightness of the red LED chip 22R, green LED chip 22G, and blue LED chip 22B adjusts the chromaticity of emitted light.

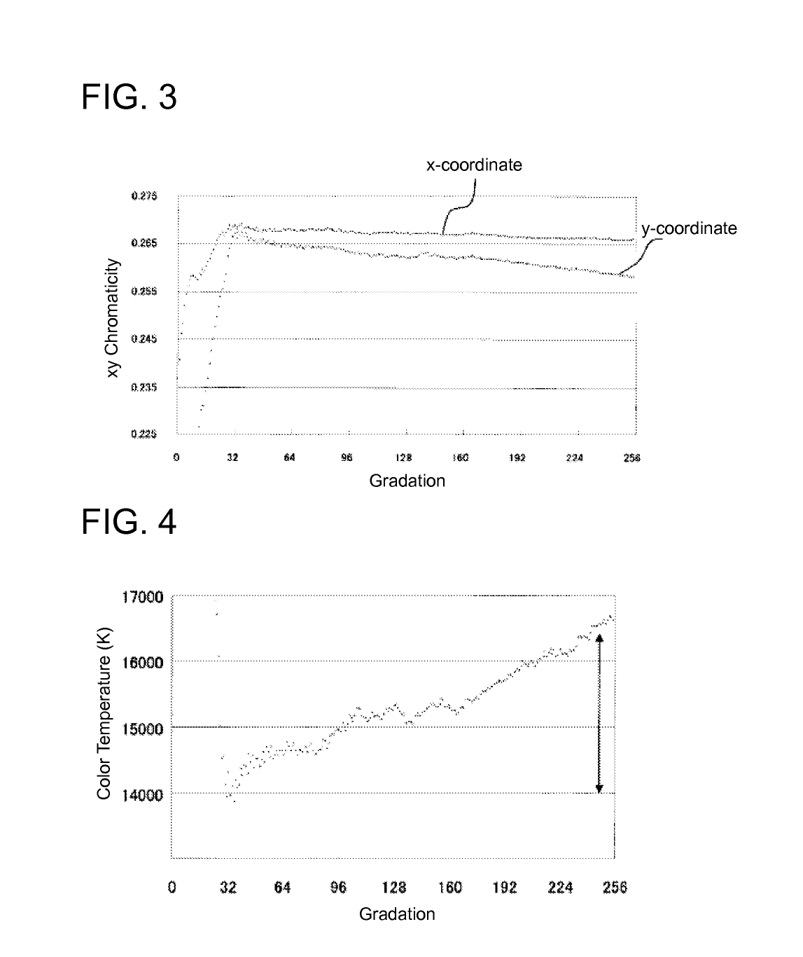

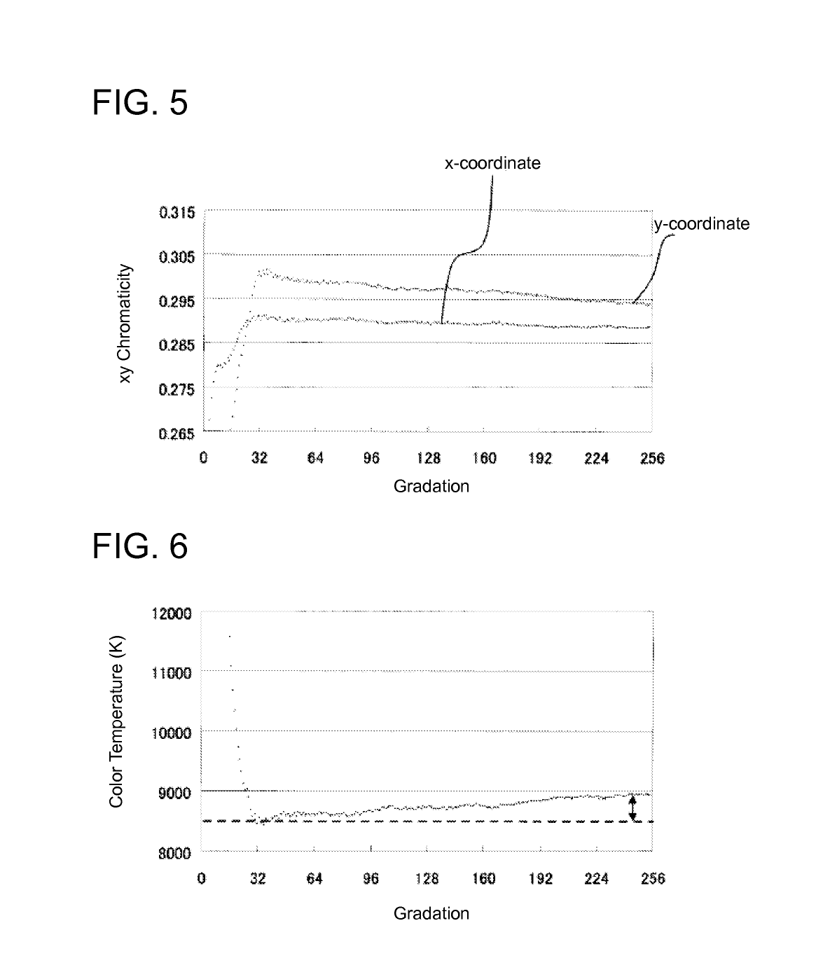

Next, in order to explain chromaticity adjustment in the liquid crystal display device of the present invention, the gradation characteristics of chromaticity and color temperature of the liquid crystal display device will be explained. FIG. 3 is a graph showing the relationship between xy chromaticity and gradation of the liquid crystal display device when white light with a color temperature of 14000 K is emitted from the backlight unit. FIG. 4 is a graph showing the relationship between color temperature and gradation of the liquid crystal display device with the same conditions as in FIG. 3. FIG. 5 is a graph showing the relationship between xy chromaticity and gradation of a liquid crystal display device when white light with a color temperature of 8500 K is emitted from the backlight unit. FIG. 6 is a graph showing the relationship between color temperature and gradation of the liquid crystal display device with the same conditions as in FIG. 5.

White light with a color temperature of 14000 K being emitted from the backlight unit 2 (a high color temperature) will be explained. As shown in FIG. 3, the x-coordinate of the xy chromaticity does not change much due to the gradation. Meanwhile, the y-coordinate decreases as the gradation increases. As shown in FIG. 4, a higher gradation of the image means a higher color temperature. In other words, it is understood from FIGS. 3 and 4 that, in the liquid crystal display device, both chromaticity and color temperature change (vary) according to the gradation when a white light with a color temperature of 14000 K is emitted.

Next, white light with a color temperature of 8500 K being emitted from the backlight unit 2 (a low color temperature) will be explained. As shown in FIG. 5, both the x-coordinate and y-coordinate of the xy chromaticity change (vary) less according to the gradation. As shown in FIG. 6, even if the gradation of the image changes, the color temperature does not change that much. In other words, it is understood from FIGS. 5 and 6 that, in the liquid crystal display device, chromaticity and color temperature do not change (vary) much according to the gradation when a white light with a color temperature of 8500 K is emitted.

FIGS. 3 to 6 above showed the behavior of one example of the liquid crystal display device, and while liquid crystal display devices normally have a difference in the degree of variation, they do have an established correlation as described above between color temperature and gradation, and chromaticity and gradation. In other words, in liquid crystal display devices, when the color temperature increases the effects of deviation in the thickness and the color filters of the liquid crystal panel 12 normally become greater, and there is a tendency to have gradation characteristics in which chromaticity and color temperature change due to gradation, or namely, a tendency for reproducibility of chromaticity and color temperature to be worse.

In the liquid crystal display device of the present invention, the gradation characteristics of chromaticity and color temperature are adjusted with high precision by suitably choosing parameters (parameters during gamma correction) that determine characteristics between brightness and gradation, and by adjusting the color temperature of light emitted from the backlight unit 2.

First, the determination of parameters (gamma correction parameters) that determine the characteristics between brightness and gradation will be explained. In the liquid crystal display device, brightness has different gradation characteristics depending on the liquid crystal panel unit 1. In the liquid crystal display device, gamma correction is performed on the image signals such that chromaticity and gradation characteristics suitable to the liquid crystal panel unit are obtained. The parameters of gamma correction are parameters for when the gamma is corrected by the gamma correcting circuit 45. In the liquid crystal display device A, immediately after the liquid crystal panel unit 1 is completed, the liquid crystal panel unit 1 is irradiated with planar light from the backlight and the parameters of gamma correction are determined. At this time, a backlight unit with a higher color temperature than a backlight unit for mass production is used as the backlight, or a backlight unit for mass production is used with the highest color temperature allowed within the range specification. The gradation characteristics of the chromaticity of the image signals are determined by the gamma correction.

In the liquid crystal display device, when the color temperature is high, the change of color temperature due to change in chromaticity is greater than when the color temperature is low. Therefore, the gradation characteristics of chromaticity of the liquid crystal display device A can be adjusted with high precision by adjusting gamma correction parameters using a backlight unit with a higher color temperature than a backlight unit for mass production or a backlight unit for mass production with the highest color temperature allowed within the range specification.

In the liquid crystal display device, the chromaticity of white light emitted from the LEDs 22 is corrected on the basis of the color temperature and image gradation of the white light emitted from the LEDs 22. The correction of chromaticity of the white light will be explained below. The correction condition configuring circuit 53 gathers the color temperature of light emitted from the LEDs 22 from the LED data signals, and gradation information of images from the signal generating circuit 46.

The correction condition configuring circuit 53 obtains a correction coefficient in accordance with the color temperature and gradation by referring to the LED adjusting LUT 501. The correction coefficient is sent to the LED data signal correcting circuit 51. The LED data signal correcting circuit 51 corrects the LED data signals on the basis of the correction coefficient and generates the adjusted LED data signals. The LED control signal generating circuit 52 generates the LED control signals on the basis of the adjusted LED data signals, and the LED driver 21 drives the lighting of the LEDs 22 (the red LED chip 22R, green LED chip 22G, and blue LED chip 22B) on the basis of these LED control signals.

As described above, in the liquid crystal display device A, the gradation characteristics of chromaticity and color temperature differ depending on the device. Therefore, in the liquid crystal display device A, the LED adjusting LUT 501 is provided, which is configured for every device. In the liquid crystal display device A of the present invention, the gradation characteristics of chromaticity and color temperature are inspected after assembly, and the LED adjusting LUT 501 is determined on the basis of the inspection results and written to the memory 50.

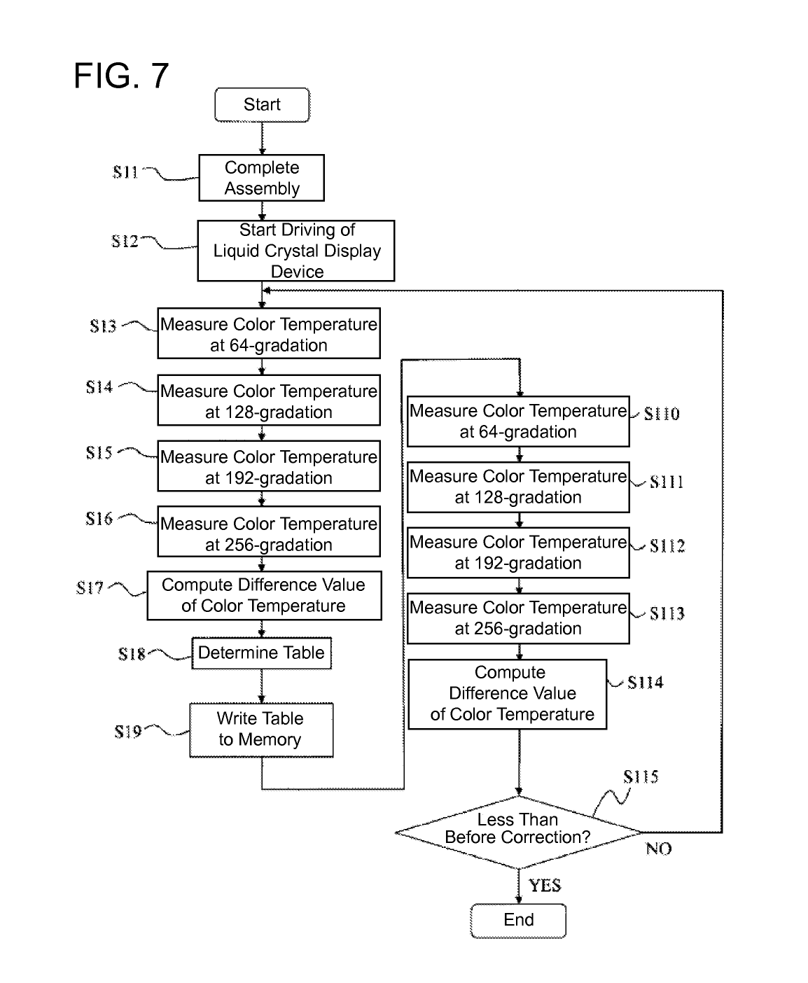

The decision procedure for the LED adjusting LUT 501 in the liquid crystal display device of the present invention will be explained below with reference to the drawings. FIG. 7 is a flow chart showing the decision procedure for the LED adjusting LUT. In the liquid crystal display device, a change in gradation leads to a change in chromaticity and color temperature, and this change becomes markedly more visible, the higher the color temperature of light emitted from the backlight unit 2 is. In general, the relationship between chromaticity and color temperature is that when color temperature is high it is sensitive to changes in chromaticity, but when color temperature is low then color temperature is not likely to change even if chromaticity changes. As a result, the selection of the LED adjusting LUT 501 is done by emitting a white light with a high color temperature from the backlight unit 2.

As shown in FIG. 7, after the liquid crystal display device A is assembled (step S11), the liquid crystal display device A is driven (step S12). At this time, a white light with a high color temperature is emitted from the backlight unit 2. Thereafter, measurement of the color temperature is conducted while switching the gradation of the image. In other words, the color temperature is measured at 64-gradation (step S13), 128-gradation (step S14), 192-gradation (step S15), and 256-gradation (step S16).

The difference in color temperature when images with each gradation from 64-gradation, 128-gradation, 192-gradation, and 256-gradation are displayed is computed (step S17). The optimum table to correct the difference computed in step S17 is determined from a plurality of different types of correction tables provided in advance (step S18). The table chosen in step S18 is written to the memory as the LED adjusting LUT 501 (step S19). When the relationship between color temperature and gradation in the liquid crystal display device A shows that the color temperature increases as the gradation increases as in FIG. 4, then the LED adjusting LUT 501 acts as a table generating adjusted LED data signals such that the brightness of the blue LED chip 22B is high when the gradation is low, and the brightness of the red LED chip 22R is high when the gradation is high.

After the LED adjusting LUT 501 is determined, the color temperature is measured at 64-gradation (step S110), 128-gradation (step S111), 192-gradation (step S112), and 256-gradation (step S113) when the LED signal has been corrected on the basis of the LED adjusting LUT 501. Thereafter, the difference in color temperature is computed for when images with each gradation from 64-gradation, 128-gradation, 192-gradation, and 256-gradation are displayed (step S114), and this difference is compared with the difference in color temperature prior to determining the LED adjusting LUT 501 (the difference that was computed in step S17) (step S115).

If the difference in color temperature when the LED data signal is done by the LED adjusting LUT 501 is lower than the difference in color temperature when the LED data signal has not been corrected, then the determining process of the LED adjusting LUT 501 ends. Conversely, if the difference in color temperature when correction is performed is higher than the difference in color temperature without correction (when there is a NO in step S115), then the color temperature is measured again from a low gradation, and the determining of the LED adjusting LUT 501 is repeated.

In step S115, the difference of the color temperature before the computation in step S114 is being compared with the difference of the color temperature prior to determining the LED adjusting LUT 501 (the value computed in step S17), but without being limited thereto, the difference may also be compared with a prescribed numerical value. By comparison with a prescribed number, the precision of the post-corrected LED data signal can be kept within a uniform range.

In such a manner, it is possible for the backlight unit 2 to have a standard color temperature that is uniform (approximately uniform) regardless of the gradation of the display image by controlling the light-emitting of the LEDs 22 with the determined LED adjusting light LUT 501. This can result in a liquid crystal display device that is capable of displaying images with high accuracy.

Furthermore, a liquid crystal display device with precision display can be obtained by merely re-writing the LED adjusting LUT 501, regardless of deviations in manufacture or assembly of the liquid crystal panel unit 1. This makes it possible to simplify the manufacturing process for liquid crystal display devices and to increase the yield of liquid crystal display devices.

### Embodiment 2

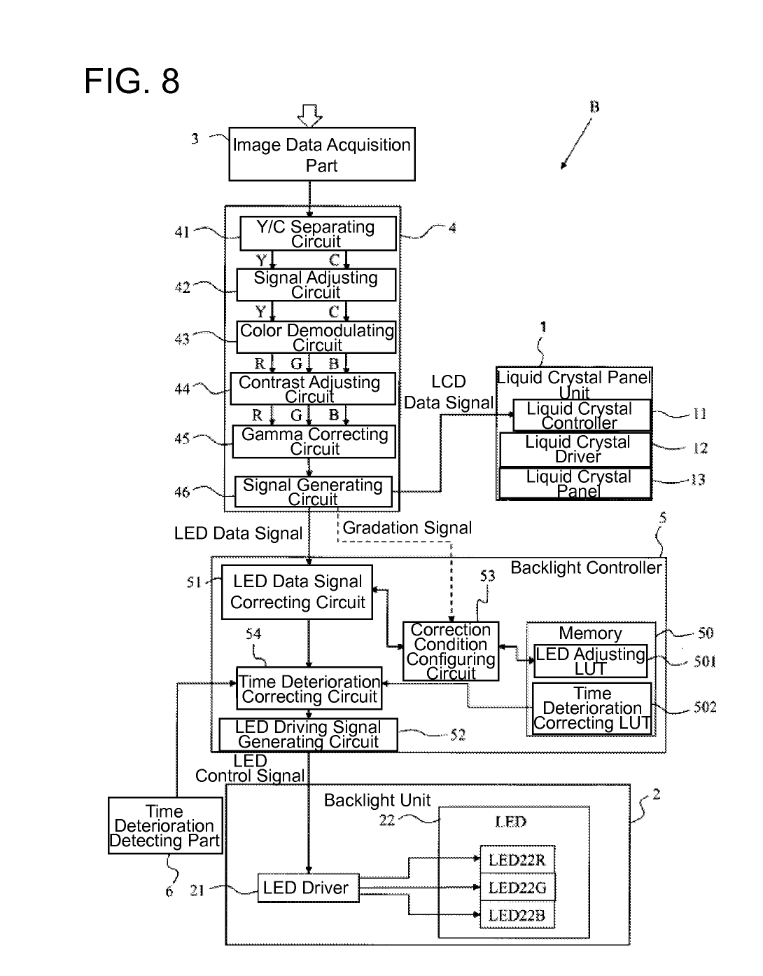

Other examples of liquid crystal display devices according to the present invention will be explained below with reference to the drawings. FIG. 8 is a block diagram showing a schematic configuration of another example of a liquid crystal display device according to the present invention. As shown in FIG. 8, a liquid crystal display device B has a time deterioration correction LUT 502 (a time deterioration table) in addition to a memory 50 and an LED adjusting LUT 501. Furthermore, an LED controller 5 is provided with a time deterioration correcting circuit 54 (a time deterioration correcting section) and a time deterioration detecting part 6. Other than these, the configuration is the same as the liquid crystal display device A, and thus, the same reference characters are given to parts that are substantially the same, and a detailed description thereof will be omitted.

In the liquid crystal display device B, a liquid crystal panel unit 1 deteriorates when the driving time is long (time deterioration). If the liquid crystal panel unit 1 deteriorates, then color temperature and chromaticity will vary, and the display precision of the images will be reduced. In the liquid crystal display device B, the time deterioration detecting part 6 is provided for detecting time deterioration of the liquid crystal panel unit 1.

In the liquid crystal display device B, if the time deterioration detecting part 6 detects time deterioration of the liquid crystal panel unit 1, then the brightness of LEDs 22 is corrected by an LED controller 5, and the variation of color temperature and chromaticity is suppressed.

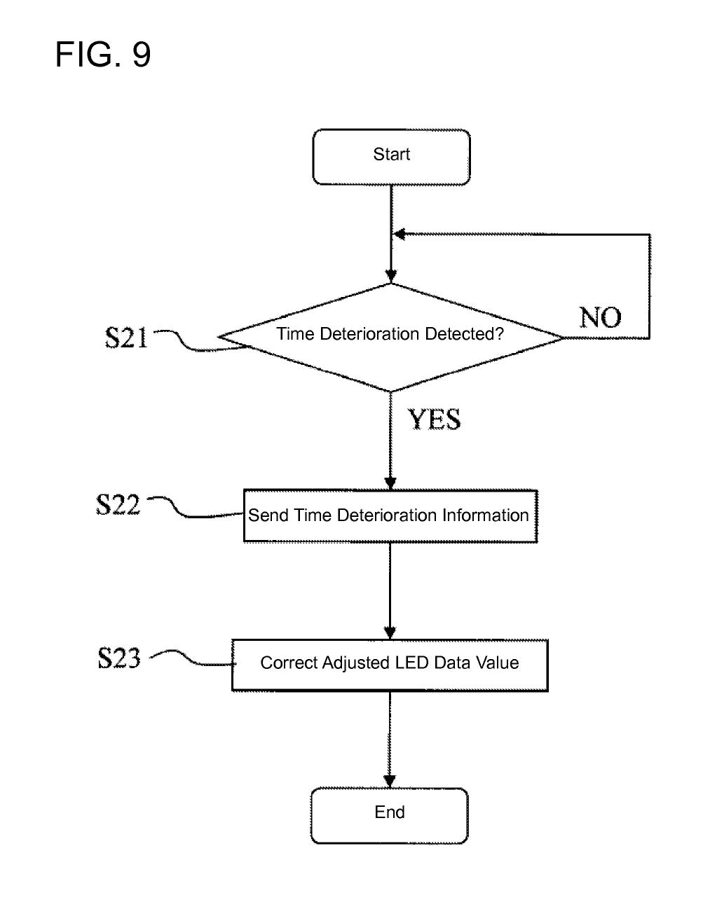

Specific methods of time deterioration correction will be explained below. FIG. 9 is a flow chart showing a procedure for correcting time deterioration. In the liquid crystal display device B, time deterioration of the liquid crystal panel unit 1 is detected by the time deterioration detecting part 6 (step S21). When time deterioration of the liquid crystal panel unit 1 is detected (YES in step S21), then the time deterioration detecting part 6 inputs time deterioration information to the LED controller 5 (step S22). The LED controller 5 drives the time deterioration correcting circuit 54, and the time deterioration correcting circuit 54 obtains a time deterioration correction coefficient from the time deterioration correcting LUT 502 on the basis of the time deterioration information.

The time deterioration correcting circuit 54 corrects a value of adjusted LED signals generated by an LED data signal correcting circuit 51 on the basis of the time deterioration correction coefficient (step S23). This adjusted LED data signal that has been corrected is sent to an LED control signal generating circuit 52 (step S24). By driving the light-emitting of the LEDs 22 with the LED control signal based on this adjusted LED signal data that has been corrected, the LEDs 22 emit light to negate the time deterioration of the liquid crystal panel unit 1, and the time deterioration of the liquid crystal panel unit 1 is corrected.

Therefore, the variation of color temperature and chromaticity caused by aging of the liquid crystal panel unit 1 of the liquid crystal display device B is corrected, thereby making it possible it obtain high precision gradation characteristics of color temperature and chromaticity over a long period of time.

A timing circuit that times the total driving time of the liquid crystal panel unit 1 may be provided as the time deterioration detecting part 6, or the time deterioration detecting part 6 may be a sensor that detects the chromaticity and (or) color temperature of light emitted from the liquid crystal panel unit 1.

In the liquid crystal display device B, the time deterioration correcting circuit 54 corrects the adjusted LED data signals, but if the memory 50 is rewritable then the LED adjusting LUT 501 may be corrected with the time deterioration correcting circuit 54. It is possible to include correction for time deterioration in the adjusted LED data signals by referring to the LED adjusting LUT 501 corrected in this manner with the LED data signal correcting circuit 51 in order to generate the adjusted LED data signals.

### Embodiment 3

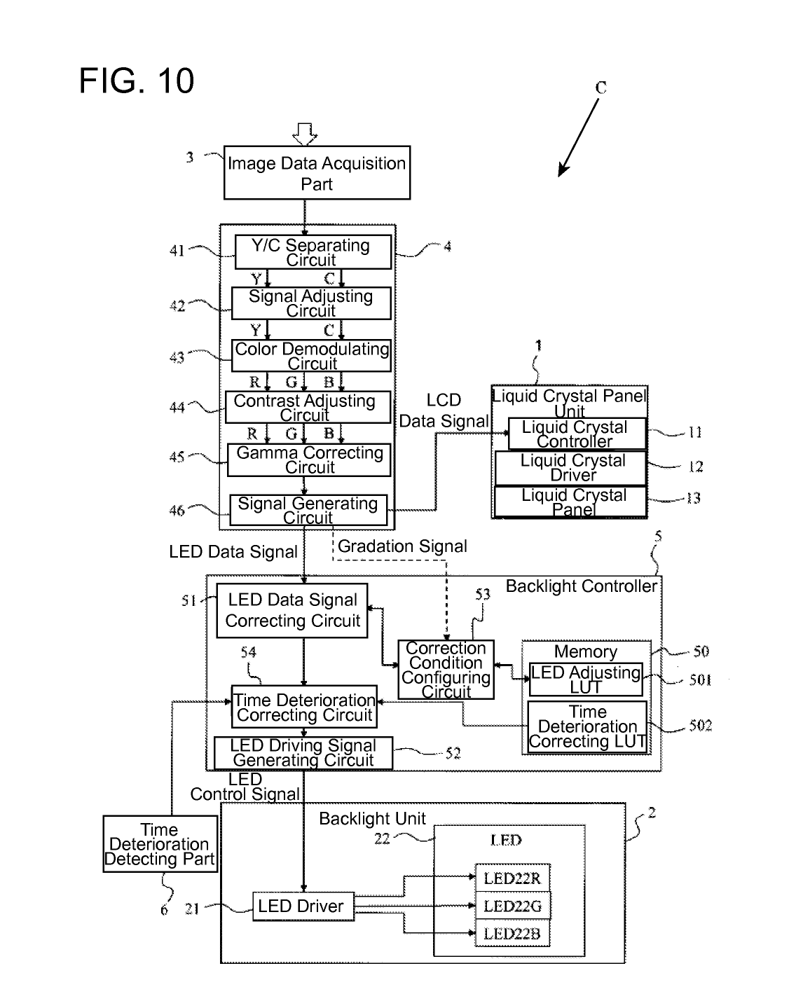

Another example of a liquid crystal display device according to the present invention will be explained below with reference to the drawings. FIG. 10 is a block diagram showing a schematic configuration of another example of a liquid crystal display device according to the present invention. As shown in FIG. 10, a liquid crystal display device C is provided with an LED time deterioration LUT 503 (an LED time deterioration correcting table), in addition to a memory 50 and an LED adjusting LUT 501. Furthermore, an LED controller 5 includes an LED time deterioration correcting circuit 55 (an LED time deterioration correcting section) and an LED time deterioration detecting part 7. Other than these, the configuration is the same as the liquid crystal display device A, and thus, the same reference characters are given to parts that are substantially the same, and a description thereof will be omitted.

In the liquid crystal display device C, LEDs 22 deteriorate (time deterioration) when the driving time is long. If the LEDs 22 deteriorate, the color temperature and chromaticity of light emitted from the LEDs 22 will vary, and the variation in gradation of the color temperature and chromaticity cannot be fully corrected even if LED data signals are corrected with an LED data signal correcting circuit 51. In the liquid crystal display device C, the LED time deterioration detecting part 7 for detecting time deterioration of the LEDs 22 is provided.

In the liquid crystal display device C, when the LED time deterioration detecting part 7 detects time deterioration of the LEDs 22, the brightness of the LEDs 22 is corrected by an LED controller 5, and variation of color temperature and chromaticity of light emitted from the LEDs 22 is suppressed.

Specific methods of time deterioration correction will be explained below. In the liquid crystal display device C, the time deterioration of the LEDs 22 is detected by the LED time deterioration detecting part 7. The LED time deterioration detecting part 7 sends information that the LEDs 22 are undergoing time deterioration to the LED controller 5. The LED controller 5 drives the LED time deterioration correcting circuit 55, and the LED time deterioration correcting circuit 55 obtains an LED correction coefficient from the LED time deterioration correcting LUT 503 on the basis of time deterioration information.

The LED time deterioration correcting circuit 55 corrects a value of adjusted LED data signals that are generated by the LED data signal correcting circuit 51, on the basis of the LED correction coefficient. This adjusted LED data signal that has been corrected is sent to an LED control signal generating circuit 52. By driving the light-emitting of the LEDs 22 with the LED control signal based on this adjusted LED signal data that has been corrected, the LEDs 22 can emit light so as to negate the time deterioration of the LEDs 22.

Therefore, the variation of color temperature and chromaticity caused by aging of the LEDs 22 of the liquid crystal display device C is corrected, thereby making it possible it obtain high precision gradation characteristics of color temperature and chromaticity over a long period of time.

A timing circuit that times the total driving time of a backlight unit 2 (the LEDs 22) may be provided as the LED time deterioration detecting part 7, or the time deterioration detecting part 7 may be a sensor that is provided in the backlight unit 2 and that detects the chromaticity and (or) color temperature of light emitted from the LEDs 22.

In the liquid crystal display device C, the LED time deterioration correcting circuit 55 corrects the adjusted LED data signals, but if the memory 50 is rewritable then the LED adjusting LUT 501 may be corrected with the LED time deterioration correcting circuit 55. It is possible to include correction for time deterioration in the adjusted LED data signals by referring to the LED adjusting LUT 501 corrected in this manner with the LED data signal correcting circuit 51 in order to generate the adjusted LED data signals.

Embodiments of the present invention were described above, but the present invention is not limited to the above embodiments. The present invention can have various modifications without departing from the spirit thereof.

### INDUSTRIAL APPLICABILITY

The present invention can be used as a display device for machines such as a flat-screen television device, flat-screen display device, mobile phone, and the like.

### DESCRIPTION OF REFERENCE CHARACTERS

1 liquid crystal panel unit

11 liquid crystal controller

12 liquid crystal driver

13 liquid crystal panel

2 backlight unit

21 LED driver

22 LED

3 image data acquisition part

4 image signal adjusting circuit

41 Y/C separating circuit

42 signal adjusting circuit

43 color demodulating circuit

44 contrast adjusting circuit

45 gamma correcting circuit

46 signal generating circuit

5 LED driving circuit

51 LED data signal correcting circuit

52 LED control signal generating circuit

53 time deterioration correcting circuit

55 LED time deterioration correcting circuit

6 time deterioration detecting part

7 LED time deterioration detecting part

1. A liquid crystal display device, comprising:
a liquid crystal panel;
a backlight that is arranged on a rear surface of the liquid crystal panel and that has LEDs as light sources, each of the LEDs comprising elements that respectively emit light of a red color, a green color, or a blue color;
a signal generating section that generates an LED data signal on the basis of display image information, the LED data signal adjusting a light-emitting luminance of the LEDs; and
a backlight driving section that controls the LEDs being turned ON and OFF on the basis of the LED data signal,
wherein the backlight driving section comprises:
an LED adjusting table including a plurality of correction coefficients that correct chromaticity of the LEDs; and
an LED data signal correcting section that corrects the LED data signal with the control coefficients by referring to the LED adjusting table.

2. The liquid crystal display device according to claim 1,
wherein the LED signal correcting section corrects the LED data signal such that the LED data signal, after correction, individually configures a luminance of the elements of the LEDs that respectively emit the red light, the green light, or the blue light.

3. The liquid crystal display device according to claim 1,
wherein the LED adjusting table is a table in which a correction coefficient is configured for each gradation of the display image, and
wherein the LED data signal correcting section receives gradation information of the display image from the signal generating section, and obtains a correction coefficient in accordance with the gradation information of the display image from the LED adjusting table.

4. The liquid crystal display device according to claim 1,
wherein the LED adjusting table is a table comprising correction coefficients such that a luminance of the blue color is high when the gradation is low and a luminance of the red color is high when the gradation is high.

5. The liquid crystal display device according to claim 1,
wherein the LED adjusting table is a table that is optimized for the individual liquid crystal panel.

6. The liquid crystal display device according to claim 5,
wherein the LED adjusting table detects a color temperature for each gradation after the manufacturing of the liquid crystal panel is complete, and a difference between the color temperatures is configured to be within a uniform range.

7. The liquid crystal display device according to claim 1, comprising:
a time deterioration detecting part that detects time deterioration of the liquid crystal panel;
a time deterioration correcting table that is included in the backlight driving section and that corrects chromaticity of the LEDs; and
a time deterioration correcting unit that is included in the backlight driving section and that corrects the LED data signal by referring to the time deterioration correcting table.

8. The liquid crystal display device according to claim 1, comprising:
a time deterioration detecting part that detects time deterioration of the liquid crystal panel;
a time deterioration correcting table that is included in the backlight driving section and that corrects chromaticity of the LEDs; and
a time deterioration correcting unit that is included in the backlight driving section and that corrects the LED adjusting table by referring to the time deterioration correcting table.

9. The liquid crystal display device according to claim 1, comprising:
an LED time deterioration detecting part that detects time deterioration of the LEDs;
an LED time deterioration correcting table that is included in the backlight driving section and that corrects chromaticity of the LEDs; and
an LED time deterioration correcting section that is included in the backlight driving section and that corrects the LED data signal by referring to the LED time deterioration correcting table.

10. The liquid crystal display device according to claim 1, comprising:
an LED time deterioration detecting part that detects time deterioration of the LEDs;
an LED time deterioration correcting table that is included in the backlight driving section and that corrects chromaticity of the LEDs; and
an LED time deterioration correcting section that is included in the backlight driving section and that corrects the LED adjusting table by referring to the LED time deterioration correcting table.
